(19) United States
(12) Patent Application Publication
(10) Pub. No.: US 2023/0206518 A1
(43) Pub. Date: Jun. 29, 2023

(54) METHOD FOR RECONSTRUCTING AN IMAGE, IN PARTICULAR AN EXACT COLOR IMAGE, AND ASSOCIATED COMPUTER PROGRAM, DEVICE AND SYSTEM

(71) Applicant: COLOR GRAIL RESEARCH, LE PLESSIS-ROBINSON (FR)

(72) Inventors: Franck Philippe HENNEBELLE, LE PLESSIS ROBINSON (FR); Rémi VAUCLIN, SANNOIS (FR)

(21) Appl. No.: 17/927,856

(22) PCT Filed: May 28, 2021
(86) PCT No.: PCT/EP2021/064435

§ 371 Date: Nov. 25, 2022

(30) Foreign Application Priority Data
May 28, 2020 (FR) FR2005664

(51) Int. Cl. G06T 11/00

(52) U.S. Cl. CPC G06T 11/006; G06T 2211/416

(57) ABSTRACT

Disclosed is a method for reconstructing a matrix image representative of a static scene under predetermined lighting conditions, including: —acquiring images, captured by a sensor using a lighting which is separate from one image to another; and —reconstructing the matrix image, in a reconstruction space separate from a native spectral space of the sensor, by determining, for each pixel, the spectral components by weighted combination of the spectral components of the native spectral space of the image sensor, the spectral components being photometrically adjusted and associated with the same pixel of each image of the captured images. the weighting is obtained by solving a linear equation system having at least the following parameters: a predetermined value matrix associated with the predetermined lighting conditions, a matrix representative of both the spectral response of the sensor and the spectral distribution of each lighting applied to each captured image.

### CROSS-REFERENCE TO RELATED APPLICATION(S)

This application is the U.S. national phase of International Application No. PCT/EP2021/064435 filed May 28, 2021 which designated the U.S. and claims priority to FR 2005664 filed May 28, 2020, the entire contents of each of which are hereby incorporated by reference.

### BACKGROUND OF THE INVENTION

### Field of the Invention

The present invention relates to a method of reconstructing an image, in particular an exact color image, the image being a raster graphic and representative of a static scene under predetermined lighting conditions.

The invention further relates to a computer program comprising software instructions which, when executed by a computer, implement such a method of reconstructing an image, in particular an exact color image.

The present invention further relates to a device for reconstructing an image, in particular an exact color image, and to a system for reconstructing an image, in particular an exact color image comprising at least one such device.

### Description of the Related Art

To reconstruct an exact color image, i.e. a theoretical image perfectly reproducing the colors of a static scene under predetermined lighting conditions, we consider an image taken under ideal conditions, namely by means of an electronic image sensor the spectral sensitivities (or spectral responses) of which correspond to the spectral sensitivities defined by the CIE XYZ (also called CIE 1931)) standard, and under predetermined lighting conditions, e.g. corresponding to a reference illuminant, belonging to the family of D illuminants corresponding to daylight illuminants, in particular a D₆₅ illuminant corresponding to natural light in daylight in a temperate zone, the color temperature of which is 6500K, or alternatively the D₅₀ illuminant the color temperature of which is 5000K, etc.

The spectral distribution of a lighting corresponding to such predetermined lighting conditions is a function of the wavelength A, denoted by e.g. D₆₅(λ) for a D₆₅ reference illuminant.

The responses (X, Y, Z)_{i,j} of the theoretical electronic image sensor with spectral sensitivities (x̅(̅λ̅)̅, y̅(̅λ̅)̅,z̅(̅λ̅)̅) at the pixel (i, j) of the image are e.g. expressed in the following form, in the presence of a predetermined lighting with a Lambertian reflectance surface ρ_{i,j}(λ), e.g. corresponding to a D₆₅ reference illuminant, and denoted by D₆₅_{_{i,j}}(λ):

$${( \begin{matrix}X \\ Y \\ Z\end{matrix} )}_{i , j} = \frac{K}{π} {\int }_{λ} {ρ}_{i , j} ( λ ) {D}_{{65}_{i , j}} ( λ ) ( \begin{matrix}\overline{x} \\ \overline{y} \\ \overline{z}\end{matrix} ) ( λ ) d λ \qquad ( 1 )$$

where K is a proportionality constant and the integration domain is the visible spectrum corresponding to the vacuum wavelengths from 380 nm to 780 nm.

The spectral sensitivities of an electronic image sensor such as a sensor embedded within a camera are in practice different from the spectral sensitivities defined by the CIE XYZ standard. Colors are generally expressed in a space called RGB for Red Green Blue (CIE RGB). Similarly, in practice, the lighting is also different from the theoretical reference illuminant considered.

In practice, a light signal received at the pixel (i, j) of the image obtained by a sensor embedded within a camera with spectral responses (r̅(̅λ̅)̅, v̅(̅λ̅)̅,b̅(̅λ̅)̅) during the lighting Eᵢⱼ(λ) of a Lambertian reflectance surface ρ_{i,j}(λ) is then generally expressed rather under as follows:

$${( \begin{matrix}R \\ V \\ B\end{matrix} )}_{i , j} = \frac{K}{π} {\int }_{λ} {ρ}_{i , j} ( λ ) {E}_{i , j} ( λ ) ( \begin{matrix}\overline{r} \\ \overline{v} \\ \overline{b}\end{matrix} ) ( λ ) d λ . \qquad ( 2 )$$

It is possible to construct a transformation matrix for space conversion, e.g. RGB, native of the image sensor into the CIE XYZ space, e.g. by taking a reference image containing a set of targets of known reflectances. However, the XYZ values thus obtained are approximate since the conversion calculated in this way leads to losses. In other words, the image obtained in practice is unsuitable for perfectly reproducing the actual colors of the scene.

There is thus a need to reconstruct a theoretical image perfectly reproducing the colors which are actually perceptible.

Moreover, such a need for faithful reconstruction of a theoretical image can also be transposed to spectra other than the visible spectrum such as infrared or ultraviolet, or any other spectrum where image reconstruction is applicable.

### SUMMARY OF THE INVENTION

To this end, the invention relates to a method of reconstructing an image, in particular an exact color image, the image being a raster graphic and representative of a static scene under predetermined lighting conditions, the method comprising the following steps:
acquisition of a plurality of images of said scene, captured by the same still image sensor, each image of said plurality being captured using a lighting distinct from one image to another,
numerical reconstruction of said raster graphic, in a reconstruction space suitable for a predetermined wavelength range, in particular the CIE XYZ color space, the reconstruction space being distinct from a native spectral space of the image sensor, by determining, for each pixel of said raster graphic, the spectral components, in particular the color components of the CIE XYZ color space, by weighted combination of the spectral components of the native spectral space of the image sensor, in particular the color components of the native color space of the image sensor, photometrically adjusted and associated with the same pixel of each image of said plurality of captured images,
   the weighting of each spectral component of the native spectral space of the adjusted image sensor, in particular of each color component of the native color space of the adjusted image sensor, is obtained by solving a system of linear equations the matrix form of which has at least the following parameters: a matrix of predetermined value associated with the predetermined lighting conditions, a matrix representative of both the spectral response of the image sensor and the spectral distribution of each lighting correspondingly applied during the acquisition of each associated image of said plurality.

According to other advantageous aspects of the invention, the method of reconstructing an exact color image comprises one or a plurality of the following features, taken individually or according to all technically possible combinations:
the method further comprises a preliminary step of selecting each lighting to be applied during said acquisition step for acquiring each image of said plurality of images of said scene captured by the image sensor, respectively, the set of lightings selected being suitable for sweeping across a whole predetermined light spectrum while meeting a predetermined spectral decorrelation criterion between each pair of lightings of said set;
each lighting corresponds to a light source of predetermined wavelength, in particular a colored light source, or is obtained by applying at least one filter of predetermined wavelength, in particular a colored filter, combined with a white light source, the transmittances of each filter, in particular of each color filter selected being at least partially decorrelated according to a criterion of different dominant wavelength taken two-by-two and/or of at least partially disjoint bandwidth taken two-by-two;
the method further comprises, after implementation of the preliminary selection step, a spectral characterization step for each lighting;
the method further comprises a preliminary step of acquiring spectral sensitivity data from the image sensor;
from the preliminary spectral characterization of each lighting and from the spectral sensitivity data of the image sensor, the method further comprises a step of obtaining the matrix representative of both the spectral responses of the image sensor and the spectral distribution of each lighting correspondingly used during the acquisition of each associated image of said plurality;
the method further comprises a step of adjusting the exposure of said reconstructed raster graphic by applying a numerical gain suitable for making the luminance of said reconstructed raster graphic identical to the mean luminance of the scene.
The method further comprises a step of converting said reconstructed raster graphic, obtained in a reconstruction space suitable for a predetermined range of wavelengths, in particular the CIE XYZ color space, into another predetermined conversion space, in particular a predetermined color space, distinct at the same time:
from said reconstruction space suitable for a predetermined range of wavelength range, in particular the CIE XYZ color space, and
the native spectral space of the image sensor, in particular the native color space of the image sensor;
the method further comprises a step of exporting said reconstructed raster graphic or said raster graphic constructed in a predetermined file format.

The invention further relates to a computer program including software instructions which, when executed by a computer, implement a method of reconstructing an exact color image as defined hereinabove.

A further subject matter of the invention is a device for reconstructing an image, in particular an exact color image, the image being a raster graphic and representative of a static scene under predetermined lighting conditions, the device being suitable for implementing the following steps:
acquisition of a plurality of images of said scene, captured by the same still image sensor, each image of said plurality being captured using a lighting distinct from one image to another,
numerical reconstruction of said raster graphic, in a reconstruction space suitable for a predetermined wavelength range, in particular the CIE XYZ color space, the reconstruction space being distinct from a native spectral space of the image sensor, by determining, for each pixel of said raster graphic, the spectral components, in particular the color components of the CIE XYZ color space, by weighted combination of the spectral components of the native spectral space of the image sensor, in particular the color components of the native color space of the image sensor, photometrically adjusted and associated with the same pixel of each image of said plurality of captured images,
   the weighting of each spectral component of the native spectral space of the adjusted image sensor, in particular of each color component of the native color space of the adjusted image sensor, is obtained by solving a system of linear equations, the matrix form of which has at least the following parameters: a matrix of predetermined value associated with the predetermined lighting conditions, a matrix representative of both the spectral response of the image sensor and the spectral distribution of each lighting correspondingly applied during the acquisition of each associated image of said plurality.

A further subject matter of the invention is a system for reconstructing an image, in particular an exact color image, the image being a raster graphic and representative of a static scene under predetermined lighting conditions, the system comprising at least the aforementioned device, an image sensor suitable for capturing a plurality of images and a lighting system suitable for applying a distinct lighting upon each image capture of said plurality, each lighting corresponding to a light source with a predetermined wavelength, such as a colored light source, or is obtained by applying at least one filter of predetermined wavelength, in particular a color filter, combined with a white light source, the transmittances of each filter, in particular of each color filter selected being at least partially decorrelated according to a criterion of different dominant wavelength (taken] two-by-two and/or of at least partially disjoint bandwidth taken two-by-two.

According to another advantageous aspect of the reconstruction system according to the invention, when the lighting is obtained by applying at least one filter of predetermined wavelength, in particular a color filter, combined with a white light source, said at least one filter of predetermined wavelength, in particular a color filter, is placed between the source of white light and the target scene of the image to be captured, or placed between said target scene of the image to be captured and the image sensor.

### BRIEF DESCRIPTION OF THE DRAWINGS

Such features and advantages of the invention will become clearer upon reading the following description, given only as a non-limiting example, and made with reference to the enclosed drawings, wherein:

FIG. 1 is a schematic representation of reconstruction system for an image, in particular an exact color image;

FIG. 2 is a flowchart of an example of reconstruction method for an image, in particular an exact color image;

FIG. 3 is a perspective front view of the rear case of a smartphone equipped with an example of an image capture module;

FIG. 4 is a perspective view of the case of FIG. 3 seen from behind;

FIG. 5 is a perspective representation of part of the image capture module shown in FIG. 3,

FIG. 6 is a front perspective view of the rear case of a smartphone equipped with another example of an image capture module;

FIG. 7 is a perspective view of the case of FIG. 6 seen from behind, and

FIG. 8 is a perspective representation of part of the image capture module shown in FIG. 6.

### DESCRIPTION OF THE PREFERRED EMBODIMENTS

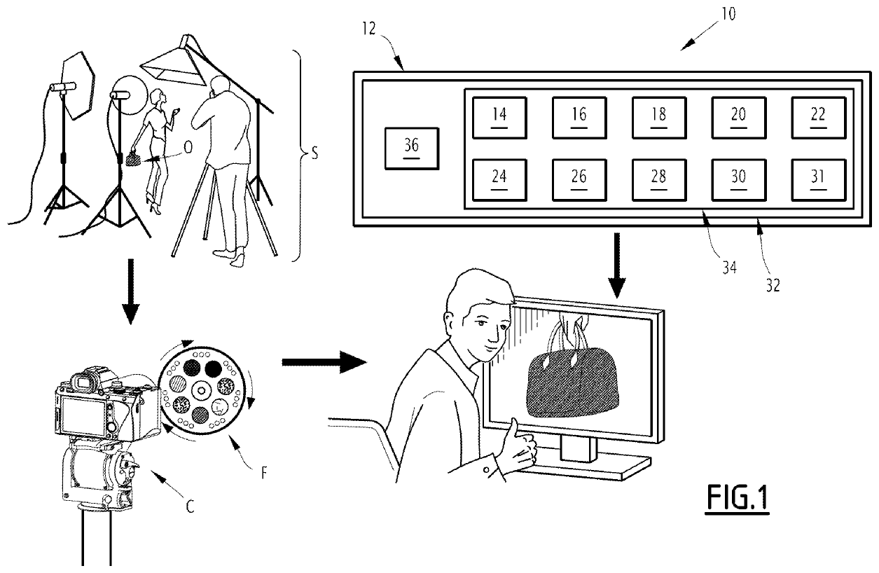

A system 10 for reconstructing an image, in particular an exact color image, is represented in FIG. 1. Thereafter, “exact color image” refers to a theoretical image perfectly reproducing the colors of a static scene S under predetermined lighting conditions.

Such a static scene S corresponds in particular, to a scene associated with high-quality photography of a product or object O, also known as a “pack shot”, used to present the product in a catalog, on a website or in a quality control process within a company.

In a manner not shown, such a static scene S corresponds to a picture-taking scene in the medical field, in particular dental, in order to obtain the real tints of the teeth of patients for the manufacture of dental prostheses by a remote prosthetist, or dermatological for the evaluation of spots or moles.

According to the present example, the system 10 for reconstructing an image, in particular an exact color image, comprises an electronic device 12 for reconstructing an image, in particular an exact color image, the image being a raster graphic and representative of the perfectly static scene S under predetermined lighting conditions, an image sensor C embedded within a camera, within a digital camera or within a mobile terminal such as a smartphone or a numerical multimedia tablet 70 with a touch screen, still in particular fixed on a foot or tripod, suitable for capturing a plurality of images and, where appropriate, a lighting system suitable for applying a distinct lighting during each image capture of said plurality, each lighting corresponding to a light source (i.e. flash), e.g. colored (not shown), or being obtained, e.g., by applying at least one colored filter F combined with a white light source (i.e. very wide spectral band) for illuminating the scene or the object to be measured, the white light being identical for each image capture of said plurality. In particular, each color filter F applied corresponds to a conventional color filter or to a color filter with a variably wide filter band and not only to a color filter with a narrow filter band such as a band-pass color filter or to a low-pass or high-pass color filter.

Moreover, the spectrum covered by the reconstruction system 10 is the smallest common between the image sensor C and the light source used (i.e. colored according to a first embodiment or white according to a second embodiment as indicated hereinabove). The present method is implemented e.g. with a CMOS sensor, which can measure from ultraviolet to infrared.

Hereinafter, the present method is described in detail focusing on an exact color image reconstruction application associated with the spectrum visible by the human eye.

Such a description can easily be transposed for any other image reconstruction associated with spectral sensitivities which lie, all or part, outside the visible spectrum such as the ultraviolet or the infrared spectrum, in particular for image reconstruction, commonly referred to as a “false color” image, for technical imaging such as astronomical imaging, satellite imaging, medical imaging, or mining prospecting, using a reconstruction space suitable for the wavelength range of the non-visible spectrum considered and/or the desired application, e.g., a “false-color” reconstruction space distinct from the CIE XYZ color space associated with the visible spectrum.

Distinct color filters, the colors being represented with distinct textures in FIG. 1, are applied e.g. by means of a disk comprising a set of predetermined color filters F arranged in a ring.

According to a particular aspect of the system according to the present example, when the light is obtained by applying at least one color filter combined with a white light source as illustrated in FIG. 1, said at least one color filter is placed between said white light source and the target scene of the image to be captured as illustrated in FIG. 1 or, in a manner not shown, placed between the image sensor and said target scene of the image to be captured.

Subsequently, the native color space of the image sensor is considered to be an RGB color space.

In the example described, it is considered that the lighting system, suitable for applying a distinct lighting during each image capture of said plurality, offers n distinct lightings (i.e. distinct lighting sources) denoted by (Eₖ)_{i,j,k=1 . . . n} with n greater than or equal to two, at a given pixel (i,j) of each image of the plurality of images. For a point in the perfectly static scene space S corresponding to the pixel (i,j) collected by the image sensor C, the image sensor is suitable for capturing an image per distinct lighting, i.e. n images and therefore n triplet color components of the native color space of the image sensor, in particular the RGB space, (Rₖ,Vₖ,Bₖ)_{i,j,k=1 . . . n} associated with the pixel (i,j).

In the example described, the electronic device 12 for reconstructing an exact color image comprises an acquisition module 14 configured for acquiring the plurality of images of said scene S, which are captured by the still image sensor C, each of the plurality of images being captured by applying a lighting distinct from one image to another, each lighting corresponding to a colored light source (not shown), or being obtained by applying at least one colored filter F combined with a white light source.

The electronic device 12 further comprises a module 16 for numerically reconstructing said raster graphic, in the CIE XYZ color space, by determining, for each pixel of said raster graphic, the XYZ color components, by weighted combination of the color components of the native color space of the image sensor of the camera, e.g. RGB color components or more generally color components supplied by the channels of the camera which is apt to be monochrome or multispectral, etc., the components being associated with the same pixel and adjusted “photometrically”, where the photometric adjustment is the combination of the application of a mathematical conversion function which reduces the supplied color components to values which take into account image exposure parameters and image sensor metadata such as ISO, exposure time, aperture, the linearity function or the black level of the sensor, while taking into account the ambient lighting, if any, of the scene, e.g. by applying a subtraction of the color components supplied to the color components obtained during the acquisition of an image without applying any additional lighting. Such technique of eliminating the ambient lighting, if any, from the scene is applicable for unknown and constant ambient lighting only between a picture-taking with additional flash and a picture-taking without flash (before and/or after each color flash within a very short time in practice). The weighting of each color component of the native color space, in particular RGB, of the image sensor, which is adjusted photometrically, is obtained by solving a system of linear equations the matrix form of which has at least the following parameters: a matrix of predetermined value associated with the predetermined lighting conditions, a matrix representative of both the spectral response of the image sensor and the spectral distribution of each lighting correspondingly applied during the acquisition of each associated image of said plurality.

More precisely, the numerical reconstruction module 16 is configured for combining the n triplets (Rₖ,Vₖ,Bₖ)_{i,j,k=1 . . . n} associated with the pixel (i,j) in order to obtain the exact theoretical color target (X,Y,Z)_{i,j} from n times the equation (2) previously indicated correspondingly associated with each lighting (Eₖ)_{i,j,k=1 . . . n}.

To obtain an exact color pixel (i,j) defined in the theoretical equation (1) it is necessary to determine the weights

$${( {W}_{{k}_{i , j}} )}_{k = 1 … n}$$

such that:

$${( \begin{matrix}X \\ Y \\ Z\end{matrix} )}_{i , j} = {\sum }_{k = 1}^{n} {{W}_{{k}_{i , j}} ( \begin{matrix}{R}_{k} \\ {V}_{k} \\ {B}_{k}\end{matrix} )}_{i , j} \qquad ( 3 )$$

$${( {W}_{{k}_{i , j}} )}_{k = 1 … n}$$

being a family of three-by-three matrices weighting the responses of the image sensor to the pixel (i,j).

By inserting equations (1) and (2) into equation (3), the following equalities are obtained:

$$\frac{K}{π} {\int }_{λ} {ρ}_{i , j} ( λ ) {D}_{{65}_{i , j}} ( λ ) ( \begin{matrix}\overline{x} \\ \overline{y} \\ \overline{z}\end{matrix} ) ( λ ) d λ = {\sum }_{k = 1}^{n} {W}_{{k}_{i , j}} ( \frac{K}{π} {\int }_{λ} {ρ}_{i , j} ( λ ) {E}_{{k}_{i , j}} ( λ ) ( \begin{matrix}\overline{r} \\ \overline{v} \\ \overline{b}\end{matrix} ) ( λ ) d λ )$$

$${\int }_{λ} {ρ}_{i , j} ( λ ) {D}_{{65}_{i , j}} ( λ ) ( \begin{matrix}\overline{x} \\ \overline{y} \\ \overline{z}\end{matrix} ) ( λ ) d λ = {\int }_{λ} {ρ}_{i , j} ( λ ) {\sum }_{k = 1}^{n} {W}_{{k}_{i , j}} ( {E}_{{k}_{i , j}} ( λ ) ( \begin{matrix}\overline{r} \\ \overline{v} \\ \overline{b}\end{matrix} ) ( λ ) ) d λ$$

a solution of which is expressed by the following equation:

$${D}_{{65}_{i , j}} ( λ ) ( \begin{matrix}\overline{x} \\ \overline{y} \\ \overline{z}\end{matrix} ) ( λ ) = {\sum }_{k = 1}^{n} {W}_{{k}_{i , j}} ( {E}_{{k}_{i , j}} ( λ ) ( \begin{matrix}\overline{r} \\ \overline{v} \\ \overline{b}\end{matrix} ) ( λ ) ) \qquad ( 4 )$$

The discretization of the above-equation (4) is equivalent to:

D₆₅_{_{i,j}}⊙(x̅|y̅|z̅)=Σₖ₌₁ⁿWₖ_{_{i,j}}(Eₖ_{_{i,j}}⊙(r̅|v̅|b̅)) (5)

with ⊙ corresponding to a product of term-to-term vectors.
By denoting by M_{i,j} the matrix representative of both the actual spectral response of the image sensor and the actual spectral distribution of each lighting correspondingly applied at the pixel (i,j) during the acquisition of each image and defined as follows:

$${M}_{i , j} = ( \begin{matrix}{E}_{{k}_{i , j}} ( {λ}_{1} ) \overline{r ( {λ}_{1} )} & {E}_{{k}_{i , j}} ( {λ}_{1} ) \overline{v ( {λ}_{2} )} & E \text{?} ( λ \text{?} ) \overline{b ( {λ}_{1} )} & … & E \text{?} ( λ \text{?} ) \overline{r ( {λ}_{1} )} & E \text{?} ( {λ}_{1} ) \overline{v ( {λ}_{1} )} & E \text{?} ( {λ}_{1} ) \overline{b ( {λ}_{1} )} \\ ⋮ & ⋮ & ⋮ & & ⋮ & ⋮ & ⋮ \\ {E}_{{k}_{i , j}} ( {λ}_{m} ) \overline{r ( {λ}_{m} )} & {E}_{{k}_{i , j}} ( {λ}_{m} ) \overline{v ( {λ}_{m} )} & E \text{?} ( {λ}_{m} ) \overline{b ( {λ}_{n} )} & … & E \text{?} ( {λ}_{m} ) \overline{r ( {λ}_{m} )} & E \text{?} ( {λ}_{m} ) \overline{v ( {λ}_{m} )} & E \text{?} ( {λ}_{m} ) \overline{b ( {λ}_{m} )}\end{matrix} ) . \qquad ( 6 )$$

$$\text{?} \text{indicates text missing or illegible when filed}$$

with m the number of wavelengths after discretization according to the wavelength of equation (4),
T_{i,j} the theoretical matrix resulting from equation (5) as defined in the following way:

$${T}_{i , j} = ( \begin{matrix}{D}_{{65}_{i , j}} ( {λ}_{1} ) \overline{x ( {λ}_{1} )} & {D}_{{65}_{i , j}} ( {λ}_{1} ) \overline{y ( {λ}_{1} )} & {D}_{{65}_{i , j}} ( {λ}_{1} ) \overline{z ( {λ}_{1} )} \\ ⋮ & ⋮ & ⋮ \\ {D}_{{65}_{i , j}} ( {λ}_{m} ) \overline{x ( {λ}_{m} )} & {D}_{{65}_{i , j}} ( {λ}_{m} ) \overline{y ( {λ}_{m} )} & {D}_{{65}_{i , j}} ( {λ}_{m} ) \overline{z ( {λ}_{m} )}\end{matrix} ) , \qquad ( 7 )$$

a change of reference illuminant, e.g. for going from D₆₅ to D₅₀ thus being, according to the example described, taken into account mathematically directly within the theoretical matrix T_{i,j},
and W_{i,j} the matrix defined as follows:

$${W}_{i , j} = ( \begin{matrix}{W}_{{1}_{i , j}} \\ ⋮ \\ {W}_{{n}_{i , j}}\end{matrix} ) \qquad ( 8 )$$

Equation (5) is then equivalent to W_{i,j} being the solution of the system of linear equations illustrated by the following matrix form:

M_{i,j}W_{i,j}=T_{i,j} (9)

with at least one predetermined theoretical value associated with the predetermined lighting conditions corresponding to the values of the theoretical matrix T_{i,j}, a matrix M_{i,j} representative both of the spectral response of the image sensor and of the spectral distribution of each lighting respectively applied during the acquisition of each image.

According to a first embodiment (not shown), the electronic device 12 for the reconstruction of an exact color image only comprises the acquisition module 14 and the reconstruction module 16, the reconstruction module 16 receiving and/or storing the weighting of each color component of the native color space, in particular RGB, of the image sensor, the weighting being photometrically adjusted and obtained beforehand by a computer external to the device for the reconstruction of an exact color image.

As an alternative as illustrated by the second embodiment shown in FIG. 1, the electronic reconstruction device 12 comprises additional modules for an autonomous computation (i.e. without dependence on an external computer) the weighting obtained by solving the system of linear equations the matrix form of which being illustrated by equation (9) hereinabove.

In particular, the electronic reconstruction device 12 further comprises a selection module 18 configured for selecting each lighting denoted by (Eₖ)_{i,j,k=1 . . . n} to be applied during said acquisition step in order to correspondingly acquire each image of said plurality of images of said scene captured by a same still image sensor, the set of lightings selected being suitable for sweeping across a whole predetermined light spectrum while meeting a predetermined decorrelation criterion between each pair of lightings of said set.

In particular, such a selection module 18 is e.g. suitable for selecting lightings each produced by means of a color filter, each lighting being produced by means of a color filter the spectral transmittance of which varies from one lighting to another, the transmittances of each selected color filter being at least partially decorrelated according to a criterion of different dominant wavelength taken two-by-two, and/or of bandwidth at least partially disjointed taken two-by-two, an overlap of the spectral bandwidths of the color filters being possible without being significant.

According to an optional supplementary aspect of the second embodiment, the electronic reconstruction device 12 further comprises a characterization module 20 configured for characterizing (i.e. measuring) each selected lighting. Such a characterization module 20 is in particular activated only once per set of selected lightings, e.g. at the installation of the image capture studio, and/or activated periodically, e.g. following an annual periodicity subsequent to the installation of the image capture studio. Such a characterization module 20 consists e.g. of one or a plurality of measuring instruments such as a spectrometer or a light meter, and a software part for controlling the instrument(s) and/or for storing and processing characterization data provided by one of the instruments or by a combination thereof. In particular, the light measurement implemented by the light meter is suitable for being used at each lighting (i.e. as soon as a flash is launched).

According to an optional supplementary aspect of the second embodiment, the electronic reconstruction device 12 further comprises a module 22 for determining the spectral sensitivity of the image sensor C. Such a spectral sensitivity determination module 22 is in particular activated only once per set of selected lightings, or activated periodically, e.g. following an annual periodicity. Such a spectral sensitivity determination module 22 e.g. consists of a measuring instrument configured for measuring the spectral sensitivity data of the image sensor C, and a software part for controlling the instrument and/or for storing and processing the measurements supplied by the instrument.

According to a complementary aspect of this second embodiment, the electronic reconstruction device 12 further comprises a computation module 24 configured to obtain, from the prior characterization of each lighting and from the spectral sensitivities information of the image sensor C, M_{i,j} the matrix representative of both the spectral response of the image sensor and the spectral distribution of each lighting correspondingly applied during the acquisition of each image to be combined for reconstructing the exact color image.

According to a complementary aspect of the second embodiment, the electronic reconstruction device 12 further comprises a solving module 26 configured for constructing and solving the system of linear equations the matrix form of which is illustrated by equation (9).

According to a particular optional aspect, the system of linear equations the matrix form of which is illustrated by equation (9), is also suitable for being simplified by the solving module 26 by considering in particular, that the theoretical spectral distribution of the lighting, e.g. corresponding to the reference illuminant D₆₅, being constant, T_{i,j} can be moreover expressed in the following form:

T_{i,j}=t_{i,j}T (10)

where t_{i,j} is a theoretical spatial gain associated with the geometry of the scene S of the reference illuminant D₆₅ associated with the pixel (i,j) and where the matrix T is normalized with an arbitrary value of the reference illuminant, e.g. D₆₅. According to such simplifying aspect, it is also considered that each distinct real lighting noted (Eₖ)_{i,j,k=1 . . . n} is a function of an identical spectral distribution in space to within a geometric factor, such that:

Eₖ_{_{i,j}}(λ)=gₖ_{_{i,j}}Eₖ(λ) (11)

where gₖ_{_{i,j}} is the spatial gain of each normalized lighting Eₖ at pixel (i,j). Then, by denoting by G_{i,j} the vector (g₁_{_{i,j}}, . . . , gₙ_{_{i,j}}) and M the matrix constructed with the normalized values Eₖ, equation (9) becomes:

$${G}_{i , j} M {W}_{i , j} = {t}_{i , j} T or further \frac{{G}_{i , j}}{{t}_{i , j}} M {W}_{i , j} = T . \qquad ( 12 )$$

When, according to a first hypothesis, G_{i,j} is known for each pixel (i,j), the values t_{i,j} can hence be selected for obtaining the desired image rendering, so that the weighting solution is then independent of the position of the pixel (i,j) which is unique for the entire image and then denoted by W.

Similarly, when, according to a second hypothesis, each distinct real lighting denoted by (Eₖ)_{i,j,k=1 . . . n} illuminates the scene identically at any point, then: g₁_{_{i,j}}= . . . =gₙ_{_{i,j}}i=t_{i,j} and then

$$\frac{{G}_{i , j}}{{t}_{i , j}}$$

can be reduced to a scalar value so that the weighting solution is then also independent of the position of the pixel (i,j) to within a factor, which gives the following equation:

MW=γT (13)

where γ is a constant to be determined and apt to define whether the subsequently reconstructed image is correctly exposed or not.

According to an additional option, the solving module 26 is suitable for using a Tikhonov regularization. Indeed, the matrix M_{i,j} of equation (6) is poorly conditioned, and to improve the solving of equation (12), the use of a Tikhonov regularization is proposed according to the example described in order to limit the norm of each vector of the matrix W and thus to prevent certain coefficients from obtaining too high values which would increase the uncertainty when solving the system of linear equations. Equation (12) can then take following form:

$$\frac{{G}_{i , j}}{{t}_{i , j}} ( \begin{matrix}M \\ α D\end{matrix} ) {W}_{i , j} = ( \begin{matrix}T \\ 0 \\ ⋮ \\ 0\end{matrix} ) \qquad ( 14 )$$

where D is a diagonal matrix and α is a regularization coefficient which can be determined empirically.

According to the second embodiment illustrated by FIG. 1, the solving module 26 is thus configured for delivering, after obtaining, by solving the system of linear equations, the weighting of each color component of the native color space, in particular RGB, of the image sensor, the weighting being photometrically adjusted to the module 16 of numerical reconstruction of the exact color raster graphic obtained in the CIE XYZ space.

As an optional addition, the electronic device 12 for reconstructing an exact color image, further comprises an adjustment module 28 configured for adjusting the exposure of said reconstructed raster graphic by applying a numerical gain suitable for making the luminance of said reconstructed raster graphic identical to the mean luminance of the scene. In particular, such a gain of the reconstructed image can be parameterized according to the needs/wishes of image reproduction or can be calculated as a function of a reference image of said scene S captured by the image sensor under a conventional white light.

As an optional addition, the electronic device 12 for reconstructing an exact color image also comprises a conversion module 30 configured for converting said reconstructed raster graphic obtained in the XYZ color space (i.e. CIE XYZ space also called CIE 1931 space) in another predetermined color space which is both distinct from said XYZ color space and distinct from the native color space, e.g. RGB, of the image sensor (i.e. the color space directly derived from the design of the image sensor and hence specific to same).

As an optional addition, the electronic device 12 for reconstructing an exact color image further comprises an export module 31 configured for exporting said reconstructed raster graphic in a predetermined file format (e.g. JPG, DNG, TIFF, etc.) for storing said raster image.

In the example shown in FIG. 1, the device 12 for reconstructing an exact color image electronic includes a data processing unit 32, consisting e.g. of a memory 34 associated with a processor 36 such as a CPU (Central Processing Unit) and/or a GPU (Graphics Processing Unit).

In the example shown in FIG. 1, the acquisition module 14, the numerical reconstruction module 16, the selection module 18, optionally the characterization module 20, optionally the spectral sensitivity determination module 22, the computation module 24, the solving module 26, the adjustment module 28, the conversion module 30 and the export module 31 are each produced, at least in part, in the form of software which can be executed by the processor 36.

The memory 34 of the data processing unit 32 is then apt to store acquisition software, numerical reconstruction software, selection software, characterization software, spectral sensitivity determination software, computation software, solving software, adjustment software, conversion software and export software.

The processor 36 is then apt to execute the acquisition software, the numerical reconstruction software, the selection software, the characterization software, the spectral sensitivity determination software, the computation software, the solving software, the adjustment software, the conversion software and the export software.

In a variant (not shown), the acquisition module 14, the numerical reconstruction module 16, the selection module 18, the characterization module 20, the spectral sensitivity determination module 22, the computation module 24, the solving module 26, the adjustment module 28, the conversion module 30 and the exportation module 31 are each produced in the form of a programmable logic component, such as an FPGA (Field Programmable Gate Array), or further in the form of a dedicated integrated circuit, such as an ASIC (Application Specific Integrated Circuit).

When at least a part of the electronic device 12 for reconstructing an exact color image is produced in the form of one or a plurality of software programs, i.e. in the form of a computer program, same is further apt to be recorded on a computer-readable medium (not shown). The computer-readable medium is e.g. a medium apt to store the electronic instructions and to be coupled to a bus of a computer system. As an example, the readable medium is an optical disk, a magneto disk, a ROM memory, a RAM memory, any type of non-volatile memory (e.g. EPROM, EEPROM, FLASH, NVRAM), a magnetic card or an optical card. A computer program containing software instructions is then stored on the readable medium.

According to the second embodiment shown in FIG. 1, the electronic device 12 comprises all the aforementioned modules 14, 16, 18, 20, 22, 24, 26, 28, 30 and 31. As an alternative, according to one or a plurality of intermediate embodiments (not shown) between the first embodiment, where the electronic device 12 comprises only the modules 14 and 16 and the aforementioned second embodiment, the electronic device 12 comprises the modules 14 and 16 and a part of the modules 18, 20, 22, 24, 26, 28, 30 and 31, the modules not comprised in the electronic device 12 being either external or else not integrated because same are optional and are not retained for the intermediate embodiment considered.

Finally, according to FIG. 1, the electronic device 12 is external to the camera or to the digital camera comprising the image sensor C and in particular, integrated into a computer, but according to another embodiment (not shown), the electronic device 12, in particular the software, is directly embedded within the camera or the digital camera comprising the image sensor.

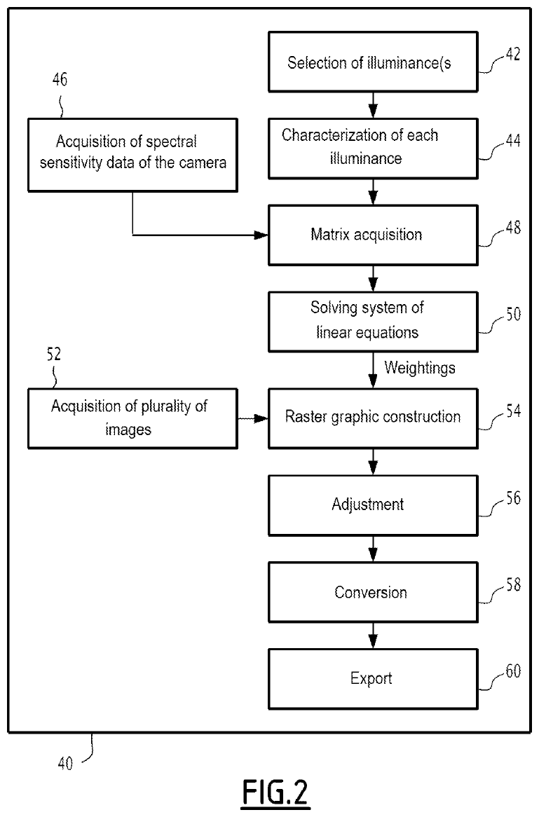

The operation of the electronic device for the reconstruction of an exact color image will now be explained with the support of FIG. 2 representing a flowchart of a method 40 for the reconstruction of an exact color image according to the second embodiment illustrated by FIG. 1.

According to an optional first step 42, the electronic device 12, via the selection module 18, selects each lighting source suitable for applying correspondingly a lighting denoted by (Eₖ)_{i,j,k=1 . . . n} during the step of acquisition of each image of said plurality of images of said scene, captured by the same still image sensor C.

Such a step 42 is optional and is implemented upstream during the hardware design of the system for reconstructing a raster graphic according to the example described, by selecting the predetermined lighting conditions to be applied, such as LEDs or filters to be used for forming the lighting system and selected from an existing catalog.

Then, according to the optional step 44 and in particular implemented during the installation of the image capture studio and then periodically, the electronic device 12, via the aforementioned characterization module 20, indeed characterizes each lighting in particular by measurement using a light meter.

In parallel, according to the optional step 46 and in particular, implemented during the installation of the image capture studio(s) and then periodically, the electronic device 12, via the aforementioned spectral sensitivity determination module 22, determines the real spectral sensitivity data of the image sensor C.

According to the step 48, the electronic device 12, via the computation module 24, obtains, from the prior characterization of each lighting source suitable for applying lighting (Eₖ)_{i,j,k=1 . . . n} and from the spectral sensitivity data of the image sensor C, the matrix M_{i,j} representative of both the spectral response of the image sensor and the spectral distribution of each lighting respectively applied during the acquisition of each image to be combined for reconstructing the exact color image.

According to the step 50, the electronic device 12, via the solving module 26, constructs and solves the system of linear equations, the matrix form of which is illustrated by equation (9), or further by equation (12) or further by equation (13) or further by equation (14) depending on the solving capabilities of module 26 and the applicable calculation hypotheses as made explicit hereinabove. Such a solving 50 provides the weighting to be applied correspondingly to each image captured with a lighting (Eₖ)_{i,j,k=1 . . . n} distinct from one image to another.

According to the step 52, the electronic device 12, via the acquisition module 14, acquires the plurality of images of said scene S captured by the same still image sensor C, each image of said plurality being captured by applying a lighting distinct from one image to the other (Eₖ)_{i,j,k=1 . . . n}. Herein, “acquisition” refers in particular to the fact that the module 14 receives, from the camera or the digital camera, the images captured by the same stationary image sensor C embedded within the camera or the digital camera.

According to step 54, the electronic device 12, via the reconstruction module 16, constructs (i.e. reconstructs) the exact color image by determining, for each pixel of said raster graphic, the XYZ color components, by weighted combination of the color components of the native color space of the image sensor, e.g. RGB color components, photometrically adjusted and associated with the same pixel of each image of said plurality of captured images.

According to the step 56, the electronic device 12, via the adjustment module 28, adjusts the exposure of said reconstructed raster graphic by applying a numerical gain suitable for making the luminance of said reconstructed raster graphic identical to the mean luminance of the scene. Such a gain of the reconstructed image can in particular, be parameterized according to the needs/wishes of image reproduction, or can be calculated as a function of a reference image of said scene S captured by the image sensor under a conventional white light.

According to the optional step 58, the electronic device 12, via the conversion module 30, converts said reconstructed raster graphic obtained in the XYZ color space into another predetermined color space which is both distinct from said XYZ color space and distinct from the native color space, in particular RGB, of the image sensor.

According to the step 60, the electronic device 12, via the export module 31, exports said reconstructed raster graphic into a predetermined file format.

A person skilled in the art will understand that the invention is not limited to the embodiments described, nor to the particular examples of the description.

Moreover, a person skilled in the art thus will conceive that the electronic device 12 and the method of reconstruction of an exact color image can be used for obtaining an automated color retouch with a perfect and constant color quality faithfully reproducing the real perception of the colors of the scene and/or of the captured object.

The electronic device 12 is thus an instrument for a colorimetric measurement of the surface/texture of flat or solid objects.

Such a faithful reconstruction of the real colors further makes possible, the application to the simulation of such colors so as to evaluate, e.g. virtually, whether the color of a product/object is in agreement with that of other products/objects or of the skin color of persons(s). Advantageously, the present method does not require any knowledge of the reflectance, brightness, texture, etc. of the objects of the scene S captured by image.

Moreover, such a reconstruction is characterized by a short computation time associated with the combination of the images.

Moreover, such a reconstruction is suitable to be used for any reference illuminant, a change of reference illuminant being taken into account in the weighting resulting from the solving of the above-mentioned system of linear equations and applied according to the method, without requiring any additional capture of image(s). In other words, a change of reference illuminant only affects the combination of images without requiring additional picture-taking.

In particular, it is possible to use the reference illuminants of the D series of illuminants representing natural daylight. The illuminants such as D₅₀, D₅₅, D₆₅ and D₇₅ are, in particular. advantageously envisaged.

Thus, according to the present method, the scene S is reproduced with the real lighting arrangement, considering that the light sources of each lighting (Eₖ)_{i,j,k=1 . . . n} produce an identical form of lighting.

Furthermore, the method of reconstructing an image can be implemented with different reconstruction devices 12.

A first implementation was previously proposed, using together a camera and a series of color flashes, e.g. produced by colored light-emitting diodes. The reconstruction device 12 can then be qualified by the portmanteau word “spectrophone” since the reconstruction device 12 makes it possible to benefit both from the functions of a telephone and of a spectrometer.

A second implementation by means of a camera, relatively powerful outdoor lighting and a series of filters was also described. In such a case, the exterior lighting is obtained e.g. by a light booth or by the use of flashes from a photo studio. The series of filters is positioned in front of the camera, e.g. a filter wheel is used.

Another example of implementation of the image reconstruction method is an implementation by an assembly including a camera, relatively powerful exterior lighting and a group of cameras. There again, the exterior lighting is obtained e.g. using a light booth or flashes from a photo studio.

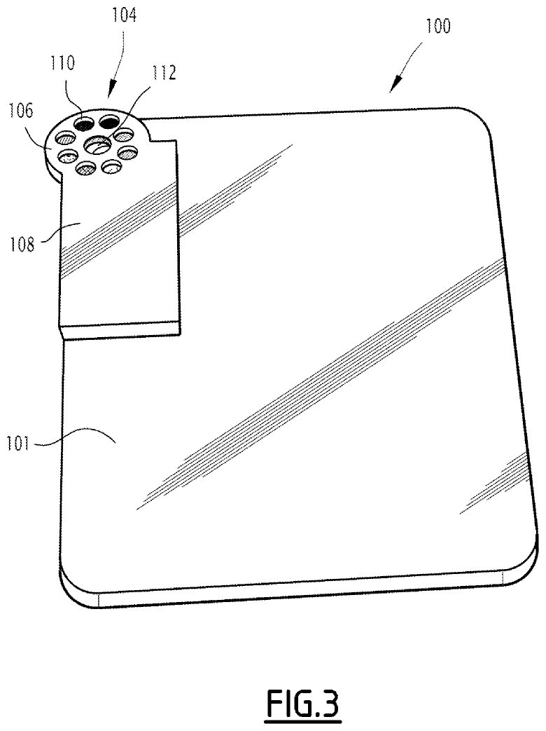

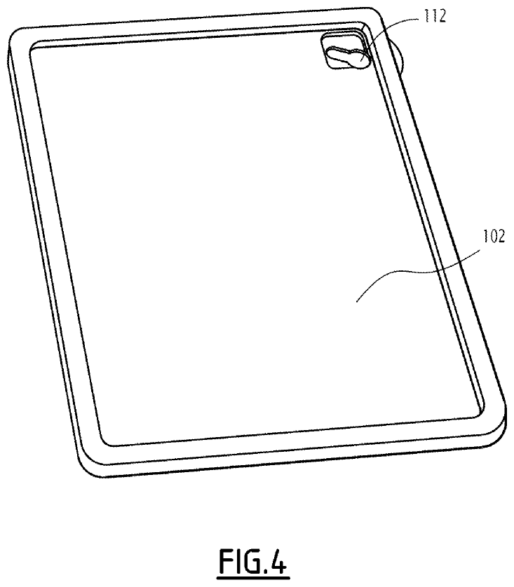

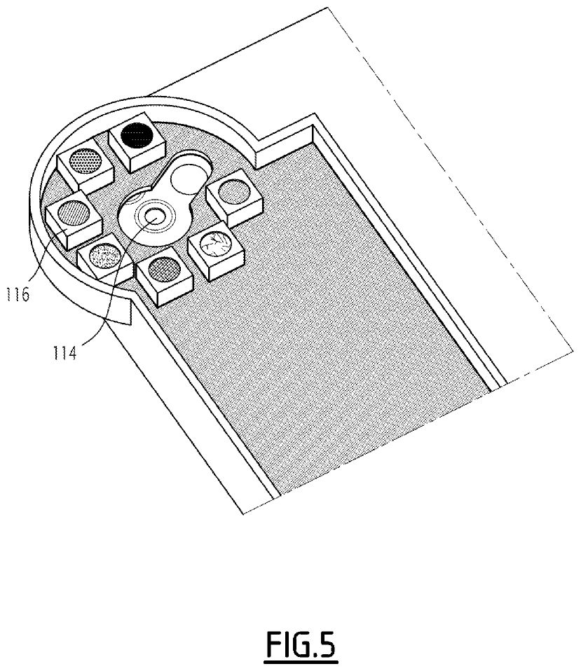

FIGS. 3 to 5 show an example of a camera and a group of cameras arranged in an image capture module 104 as such arranged on a smartphone. More precisely, FIG. 3 is a schematic view of a smartphone case seen from the front, FIG. 4 is a schematic view of a smartphone case seen from the back and FIG. 5 is a detail view of the image capture module.

The case 100 of the smartphone shown in FIGS. 3 to 5 has a case (rear) with a front face 101 and a rear face 102. The front face 101 is equipped with the image capture module 104.

The image capture module 104 includes two parts 106 and 108. The first part 106 is the optical part while the second part 108 is the mechanical part for holding the optical part.

The first part 106 has the shape of a ring delimiting peripheral openings 110 and a central opening 112.

The number of peripheral openings 106 in FIG. 3 is 5.

The peripheral openings 106 are arranged in a circle centered on the central opening 112.

The central opening 112 is passing through as shown in the three FIGS. 3 to 5.

According to the example shown in FIG. 3, the second part 108 has a substantially parallelepiped shape, the first part 106 being positioned at one of the vertices of the parallelepiped.

With reference to FIG. 5, the image-taking module 104 includes a central camera 114 and 7 satellite cameras 116.

The central camera 114 together with the 7 satellite cameras 106 form the image sensor C.

The central camera 114 is part of the native acquisition module of the smartphone while the 7 satellite cameras 116 are added with respect to the native acquisition module of the smartphone.

The central camera 114 is positioned facing the central opening 112. In particular, it results therefrom that the field of the central camera 114 is not hidden by the edges of the central aperture 112.

Similarly, each satellite camera 116 is positioned facing a respective peripheral opening 110.

One of the peripheral openings 110 is positioned facing another sensor of the native acquisition module of the smartphone.

A filter of different color is positioned in front of each satellite camera 116. Furthermore, the size of the satellite cameras 116 is smaller than the size of the central camera 114, so that each satellite camera 116 can be considered to be a “mini-camera”.

It should be noted that, in the example described, the satellite cameras 116 have the same dimensions.

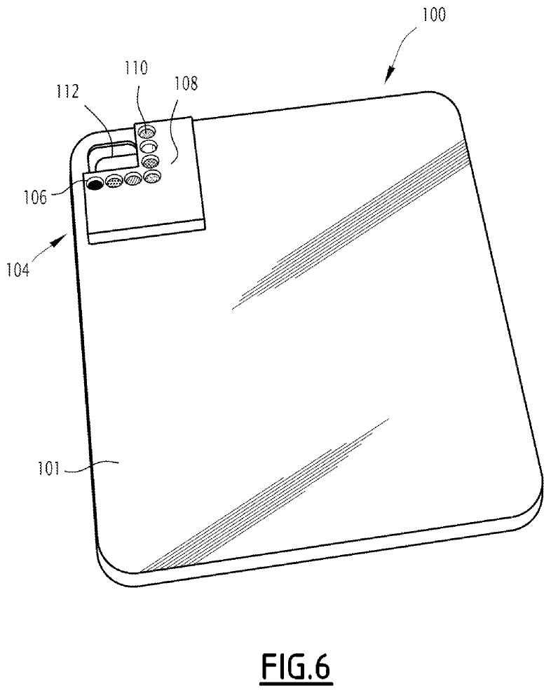

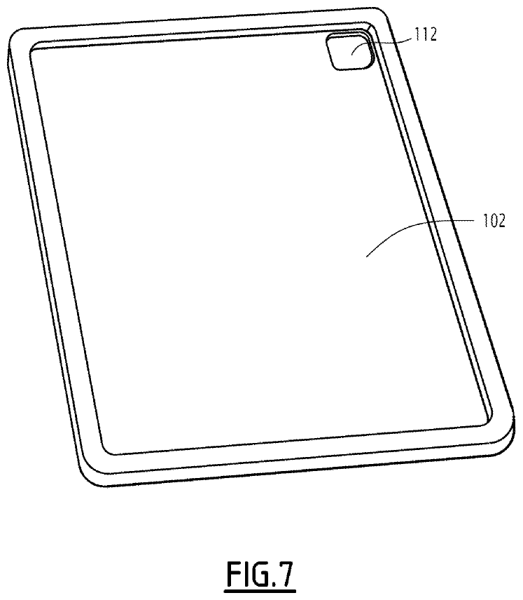

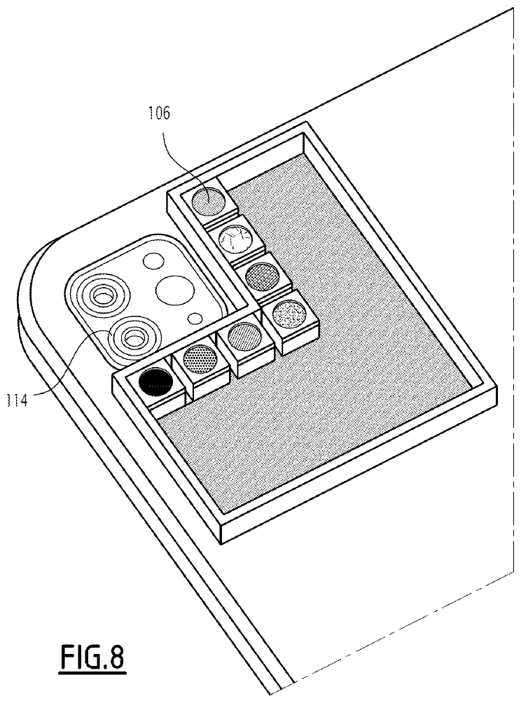

FIGS. 6 to 8 correspond to another embodiment wherein the image-taking module 104 has an L shape and the additional cameras 116 are arranged in an L.

Furthermore, the central opening 112 has a rectangular shape, which makes it possible not to mask the native acquisition module of the smartphone.

In each of the cases, a device for holding in position such as a stand for the image-taking module 104, can be used in addition.

The use of a plurality of cameras 114 and 116 makes it possible to take only one image, which is a clear time saving and above all makes the process compatible with the use thereof for a video.

With the positions of the cameras 114 and 116 which are known, it is possible to directly perform a reconstruction or to recolor the images.

Furthermore, it should be noted that the present method can be used in combination with other mathematical treatments.

In particular, it is possible to implement the following steps:
lighting the object by an external illuminant with unknown and variable illuminance,
emitting at least one flash of light illuminating the object, each flash of light being emitted by a source and having a known illuminance in a range of wavelengths,
collecting the wave reflected by the object, so as to form at least one image on a sensor, the collection step being applied at flash emission instants and without flash emission,
obtaining an equation with a plurality of unknowns, the equation being obtained from the images formed, the reflectance of the object and the illuminance of the external illuminant being two unknowns of the equation,
solving the equation,

the step of solving the equation comprising:
the computation of solution points of the equation,
the interpolation of points calculated by an interpolation function, and
the use of a first approximation for the solution of the equation, the first approximation being an approximation according to which each image collected during the emission of the same flash of light comes from the emission of a distinct flash of light, resulting in the equation being an over-determined equation from which a plurality of sub-equations to be solved are extracted, said sub-equations forming an over-determined system to be solved and according to which the solution of the equation includes solving each sub-equation so as to obtain a plurality of solution reflectances and calculating the mean of the plurality of solution reflectances so as to obtain the reflectance of the object.

According to a specific embodiment, the equation solving step further includes the use of a second approximation according to which the interpolation function determines the stability points of the equation and according to which the stability points are used in the equation solving step, the stability points being the points of the interpolation function for which the solution is less sensitive to instabilities.

According to another embodiment or in addition, the step of solving the equation further includes the use of a third approximation according to which the lighting of the external illuminant at the instant of emission of a flash of light is equal to the lighting of the external illuminant at a previous instant, the third approximation being used during the step of solving the equation, the method comprising the step of taking a reference image by collecting the wave reflected by the object so as to form at least one image on a sensor in the absence of a flash emitted by the source, the step of solving the equation comprising the subtraction of a reference equation so as to obtain a simplified equation, the reference equation being obtained from the reference image.

According to yet another embodiment or in addition, the source and the sensor are arranged on the same apparatus.

According to yet another embodiment or in addition, a plurality of flashes of light are emitted, each flash having a maximum illuminance, the collection step being used for each flash of light emitted and at least two flashes of light having a maximum illuminance at wavelengths separated by at least 20 nanometers.

According to yet another embodiment or in addition, the second approximation is used during the step of solving the equation and wherein the interpolation function is a weighted combination of base functions set in place by a finite number of interpolation points, in particular cubic splines, each interpolation point being a point of stability of the equation.

According to yet another embodiment or in addition, a plurality of light flashes are emitted, each flash having a maximum lighting at a certain wavelength, the collection step being used for each flash of light emitted, and the interpolations points satisfying at least the following property: the number of interpolation points is equal to the number of flashes.

According to yet another embodiment or in addition, the method further comprises the steps of estimating a time interval of the variation of the illuminance of the external illuminant and, from the estimated time interval for said variation, determining the frequency at which the step of taking a reference image has to be reiterated in order for the third approximation to remain valid

According to yet another embodiment, the method further comprises a step of adjusting the exposure of said reconstructed raster graphic by using a calibration test pattern, as can be done in particular, in the field of spectroscopy.

Thus, in all the embodiments which can be combined to form new embodiments, it will be well understood that the method can be used, starting from a series of photos with flashes, for reconstruction with a perfect standard illuminant, by computation and a standard eye. The illuminant is any type of illuminant such as a D₅₀, D₆₅ or A. The standard eye corresponds e.g. to CIE 1931 2° or CIE 1960 10° standards. Such example relating to the visible extends immediately to other spectral bands, e.g. an illuminant and a standard eye sensitive to IR.

1-15. (canceled)

16. A method of reconstructing an image, the image being a raster graphic and representative of a static scene under predetermined lighting conditions, the method comprising the following steps:
acquisition of a plurality of images of said scene, captured by a still image sensor, each image of said plurality being captured using a lighting distinct from one image to another,
numerical reconstruction of said raster graphic, in a reconstruction space suitable for a predetermined wavelength range, the reconstruction space being distinct from a native spectral space of the image sensor, by determining, for each pixel of said raster graphic, the spectral components by weighted combination of the spectral components of the native spectral space of the image sensor photometrically adjusted and associated with the same pixel of each image of said plurality of captured images,
the weighting of each spectral component of the native spectral space of the adjusted image sensor being obtained by solving a system of linear equations, the matrix form of which has at least the following parameters: a matrix of predetermined value associated with the predetermined lighting conditions, a matrix representative of both the spectral response of the image sensor and the spectral distribution of each lighting correspondingly applied during the acquisition of each associated image of said plurality.

17. The method according to claim 16, wherein the reconstruction space is the CIE XYZ color space, the spectral components are the color components of the CIE XYZ color space and the spectral components of the native spectral space of the image sensor are the color components of the native color space of the image sensor.

18. The method according to claim 16, wherein the method further comprises a preliminary step of selecting each lighting to be applied during said acquisition step for acquiring each image of said plurality of images of said scene captured by the image sensor, respectively, the set of lightings selected being suitable for sweeping across a whole predetermined light spectrum while meeting a predetermined spectral decorrelation criterion between each pair of lightings of said.

19. The method according to claim 18, wherein each lighting corresponds to a light source with predetermined wavelength, the light source being a colored light source.

20. The method according to claim 18, wherein each lighting corresponds to a light source with predetermined wavelength, the light source being obtained by applying at least one filter with predetermined wavelength combined with a white light source.

21. The method according to claim 20, wherein the transmittances of each filter being at least partially decorrelated according to a criterion of different dominant wavelength taken two-by-two and/or of at least partially different bandwidth taken two-by-two

22. The method according to claim 18, wherein the method further comprises, after implementation of the preliminary selection step, a spectral characterization step for each.

23. The method according to claim 16, wherein the method further comprises a preliminary step of acquiring spectral sensitivity data from the image.

24. The method according to claim 22, wherein the method further comprises a preliminary step of acquiring spectral sensitivity data from the image, and wherein from the prior spectral characterization of each lighting and from the spectral sensitivity data of the image sensor, the method further comprises a step of obtaining the matrix representative both of the spectral responses of the image sensor and of the spectral distribution of each lighting correspondingly used during the acquisition of each associated image of said plurality.

25. The method according to claim 16, wherein the method further comprises a step of adjusting (56) the exposure of said reconstructed raster graphic by applying a numerical gain suitable for making the luminance of said reconstructed raster graphic identical to the mean luminance of the scene or by using a calibration test pattern.

26. The method according to claim 16, wherein the method further comprises a step of converting (58) said reconstructed raster graphic obtained in the reconstruction space suitable for a predetermined wavelength range, into another predetermined conversion space, distinct at the same time:
from said reconstruction space suitable for a predetermined range of wavelength range, and
from the native spectral space of the image sensor.

27. The method according to claim 26, wherein the another predetermined conversion space a color space of a reference illuminant of the D series of illuminants.

28. The method according to claim 27, wherein illuminant belong from the D50, D55, D65 or D75 series.

29. The method according to claim 16, wherein the method further comprises a step of exporting said reconstructed raster graphic or said constructed raster graphic in a predetermined file format.

30. The method according to claim 16, wherein the image sensor includes a central camera and a plurality of satellite cameras arranged in a circle or in an L.

31. The method according to claim 16, wherein the method further includes:
lighting the object by an external illuminant with unknown and variable illuminance,
emitting at least one flash of light illuminating the object, each flash of light being emitted by a source and having a known illuminance in a range of wavelengths,
collecting the wave reflected by the object, so as to form at least one image on a sensor, the collection step being applied at flash emission instants and without flash emission,
obtaining an equation with a plurality of unknowns, the equation being obtained from the images formed, the reflectance of the object and the illuminance of the external illuminant being two unknowns of the equation, and
solving the equation,
the step of solving the equation comprising:
the computation of solution points of the equation,
the interpolation of points calculated by an interpolation function, and
the use of a first approximation for the solution of the equation, the first approximation being an approximation according to which each image collected during the emission of the same flash of light comes from the emission of a distinct flash of light, resulting in the equation being an over-determined equation from which a plurality of sub-equations to be solved are extracted, said sub-equations forming an over-determined system to be solved and according to which the solution of the equation includes solving each sub-equation so as to obtain a plurality of solution reflectances and calculating the mean of the plurality of solution reflectances so as to obtain the reflectance of the object.

32. A non-transitory computer-readable medium on which is stored a computer program including software instructions which, when executed by a computer, implement a method of reconstructing an exact color image, the image being a raster graphic and representative of a static scene under predetermined lighting conditions according to claim 16.

33. A device for reconstructing an image, the image being a raster graphic and representative of a static scene under predetermined lighting conditions, the device being suitable for:
acquiring a plurality of images of said scene, captured by a still image sensor, each image of said plurality being captured using a lighting distinct from one image to another,
numerically reconstructing said raster graphic, in a reconstruction space suitable for a predetermined wavelength range, the reconstruction space being distinct from a native spectral space of the image sensor, by determining, for each pixel of said raster graphic, the spectral components by weighted combination of the spectral components of the native spectral space of the image sensor photometrically adjusted and associated with the same pixel of each image of said plurality of captured images,
the weighting of each spectral component of the native spectral space of the adjusted image sensor being obtained by solving a system of linear equations the matrix form of which has at least the following parameters: a matrix of predetermined value associated with the predetermined lighting conditions, a matrix representative of both the spectral response of the image sensor and the spectral distribution of each lighting correspondingly applied during the acquisition of each associated image of said plurality.

34. A system for reconstructing an image, the image being a raster graphic and representative of a static scene under predetermined lighting conditions, the system comprising at least the device according to claim 33, an image sensor suitable for capturing a plurality of images and a lighting system suitable for applying a distinct lighting upon each image capture of the plurality, each lighting corresponding to a light source of a predetermined wavelength.

35. The system according to claim 34, wherein when the lighting is obtained by applying at least one filter of predetermined wavelength, combined with a white light source, said at least one filter of predetermined wavelength, is placed between said source of white light and the target scene of the image to be captured, or placed between said target scene of the image to be captured and the image sensor.
